(19) United States
(12) Patent Application Publication
(10) Pub. No.: US 2009/0113775 A1
(43) Pub. Date: May 7, 2009

(54) SYSTEM FOR DISTRIBUTING VISUAL CONTENT TO A TARGETED DISPLAY

(76) Inventor: Jessica Dee Netter, Stillwater, MN (US)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/262,893

(22) Filed: Oct. 31, 2008

Related U.S. Application Data
(60) Provisional application No. 60/984,857, filed on Nov. 2, 2007.

(51) Int. Cl. G09F 21/04; G05B 15/00

(52) U.S. Cl. 40/591; 700/13; 700/15

(57) ABSTRACT

A media system for distributing visual content includes a display and a host. The host is remotely located from the display and coupled to the display over a communication network. The display is supported by an article. The host includes a computer storage medium including visual content. At least a portion of the visual content is submitted to the host by a client. The host includes a processor configured to selectively transmit visual content to the display and configured to receive data corresponding to display activity of the selected visual content on the display. A reporting module reports the data corresponding to the display activity to the client and the subscriber.

### CROSS-REFERENCE TO RELATED APPLICATION

The present application is based on and claims the benefit of U.S. provisional patent application Ser. No. 60/984,857, filed Nov. 2, 2007, the content of which is hereby incorporated by reference in its entirety.

### BACKGROUND

Signs, flyers and billboards are all example ways in which messages can reach people while they are outside of the home. Such messages can include commercial advertising and non-commercial advertising, and public notices. In general, these types of messages are one-way communications through a medium in which a sponsor of the message is identified and the message is controlled by the sponsor. For example, advertising can be attached to transportable objects, such as automobiles, buses, trains and etc., as well as attached to fixed objects, such as billboards (digital or traditional), bulletin boards and storefronts. These types of media are viewable by people traveling in their vehicles or for viewing by bicyclists or pedestrians on the street. A more recently used form of media includes digital signage where messages are displayed on an electronic screen or digital display.

Some fixed media can display a plurality of messages in a paneled rotation using a mechanical system or can be digitally displayed on a screen. The digital displays can range from simple text and still images to full-motion video with or without audio and can be changed an infinite amount of times without modification to the physical sign. In addition, messages can be presented at specific locations at specific times to better target your audience. Examples of digital displays include LCD or plasma display panels, digital billboards, projection screens, etc. that can be controlled electronically using a computer or other computing devices.

Digital billboards allow static or video-type advertisements to rotate in succession. However, there is only a finite amount of space available for billboards and signs along the sides of highways and roads and these billboards and signs are only able to reach those people who happen to drive down that particular road. Being able to reach a greater audience is desirable for all advertisers and those that disseminate public service announcements.

The discussion above is merely provided for general background information and is not intended to be used as an aid in determining the scope of the claimed subject matter.

### SUMMARY

Embodiments are directed to a media system and method for distributing visual content. The media system includes a display and a host. The host is remotely located from the display and coupled to the display over a communication network. The display is supported by an article. The host includes a computer storage medium having visual content storage that stores visual content submitted by a client of the system or by network management. The host includes a processor configured to transmit select visual content from the visual content storage to the display and configured to receive data from the display. A reporting module reports the data to the client and the subscriber.

Embodiments are also directed to a display system. The display system includes a display housed in a transportation vehicle and configured to render an image supported by a window of the transportation vehicle. The window includes an exterior facing side, which at least renders the image for viewing by a person exterior to the transportation vehicle. The display system also includes a (mobile or fixed) processing unit including a storage device containing visual content received from a host remotely located from the display system and coupled to the processing unit through a communication network. The processing unit is configured to transmit visual content to the display and transmit data to the host.

These and various other features and advantages will be apparent from a reading of the following Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 illustrates a schematic diagram of a media system for distributing visual content under one embodiment.

FIG. 2 illustrates a schematic diagram of a host under one embodiment of the media system illustrated in FIG. 1.

FIG. 3 illustrates a schematic diagram of a display system under one embodiment of the media system illustrated in FIG. 1.

FIG. 4 is a flowchart illustrating a method of distributing visual content under one embodiment.

FIG. 5 is a flowchart illustrating a method of displaying visual content under one embodiment.

FIG. 6 is a side view of one embodiment of a vehicle configured to house the display system illustrated in FIGS. 1 and 3.

FIG. 7 is a rear view of the vehicle illustrated in FIG. 6.

### DETAILED DESCRIPTION

Embodiments of the disclosure pertain to a media system for disseminating or distributing visual content to a targeted location. Example visual content includes images and messages in the form of commercial advertising, non-commercial advertising, personal or opinion related messages and public notices. In particular, embodiments of the disclosure pertain to a media system for distributing digital visual content for display on an article, such as on a window of a vehicle.

In one aspect, embodiments describe clients of the media system registering with a host to submit their visual content to be displayed by a display device that is supported by an article in a targeted location. In another aspect, embodiments describe subscribers of the media system registering to facilitate the display of the visual content using the article in exchange for reward points or other type of reward program. For example, an article can be a piece of the subscriber's personal property or a piece of someone else's personal property.

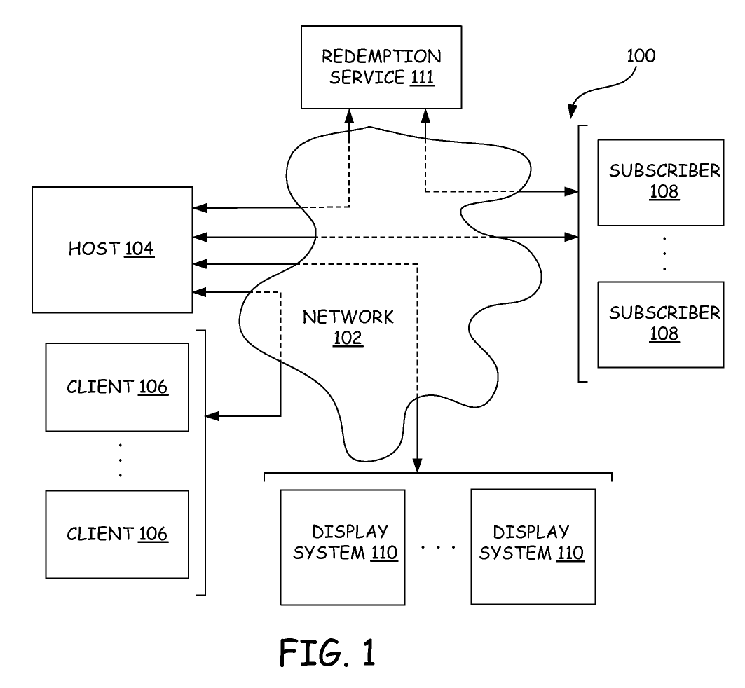

FIG. 1 illustrates a schematic diagram of a media system 100 under one embodiment. Media system 100 is for use in a suitable computing system environment. Examples of well known computing systems, environments, and/or configurations that are suitable for use with individual components of system 100 include, but are not limited to, personal computers, server computers, handheld or laptop devices, multiprocessor systems, microprocessor-based systems, mobile processors, set top boxes, programmable consumer electronics, network PCs, minicomputers, mainframe computers, automobile computers, distributed computing environments that include any of the above systems or devices, and the like.

Embodiments of media system 100 are described below in the general context of computer-executable instructions, such as program modules, being executed by a computer. Generally, program modules include routines, programs, objects, components, data structures, etc. that perform particular duties or implement particular abstract data types. Embodiments are designed to be practiced in distributed computing environments where tasks are performed by remote processing devices linked through a communications network. In a distributed computing environment, program modules are located in both local and remote computer storage media (or computer readable media) including memory storage devices.

Media system 100 includes a network 102, a host 104, a plurality of clients 106, a plurality of subscribers 108, plurality of display systems 110 and a redemption service 111. Network 102 can be any of a variety of secured wireless communication systems that can receive and transfer data using a communications protocol or standard. In the case where network 104 is a cellular network, example standards include SMS (short message service), GSM (global system for mobile communication) and other types of data standards that are particular to cellular networks, such as enhanced data rate standards like EDGE, 3G and etc. In another embodiment, other non-cellular communication standards can be used, such as WiFi, WiMax, Bluetooth, radio frequency (RF), Infrared (IrDA) and etc. In yet another embodiment, network 104 can be a satellite network where data are received and transmitted by broadcasting a signal with a communications satellite using transmission towers.

Host 104 is a central media distribution server capable of hosting and distributing information over network 102. In particular, host 104 is configured to store, transmit, receive and process data and visual content for the plurality of clients 106, the plurality of subscribers 108, the plurality of display systems 110 and redemption service 111. It should be realized that not all content will be transmitted to all of the plurality of display system 110 of media system 100 or that all of the plurality of display systems 110 will receive all of the visual content. It is possible that visual content is transmitted to only one or only a select amount of display systems 110. Host 104 is capable of including client and server type software. For example, host 104 can include TCP/IP web communications protocol or similar protocols for communicating with peripheral devices, such as clients 106 via client devices, subscribers 108 via subscriber devices, display systems 110 and redemption service 111. However, it should be realized that host 104 is capable of communicating with peripheral devices through other communication means.

Each of the plurality of clients 106 can register to establish an account over network 102 with host 104. At the time of registration, each client 106 receives a corresponding username and password and submits client profile information, such as name, type of visual content wanting to distribute and etc., to host 104. Client profile information and username and password information are stored with host 104.

At registration, or any time thereafter, each client 106 can submit visual content to host 104 to be distributed to display systems 110 for display. For example, each client can upload visual content in the form of, but are not limited to, jpg, .tiff, .bmp, .wmv files in either a compressed or non-compressed format. For example, one type of client 106 includes an advertiser who agrees to pay a fee in exchange for their advertisements being displayed on select or all display systems 110. Other types of clients include organizations wanting to disseminate public information. For example, law enforcement agencies or other government agencies may want to have traffic safety, traffic operations, AMBER alert messages or other messages displayed at particular locations at specific times. AMBER alert message are notifications to be distributed to the general public via a media outlet when police confirm a child's abduction. In other examples, individuals or organizations may want to express opinions or images they want to disseminate via display systems 110.

Host 104 screens visual content submitted by each client 106. In particular, host 104 requires a client 106 to modify their submitted visual content if it is considered to be vulgar, obscene, illegal or otherwise deemed unacceptable or inappropriate. Other example types of inappropriate content include copyrighted content, slanderous content, or DRM (digital rights management) content After visual content is approved, host 104 formats the submitted visual content depending on the type of display and depending on file type. It should be realized that host 104 may modify the message directly if the visual content needs reformatting such that it can be handled by media system 100. After the visual content from client 106 is approved and optionally formatted, the visual content is stored with host 104.

Each of the plurality of subscribers 108 also establishes an account with host 104. At the time of registration, each subscriber 108 receives a corresponding username and password and submits subscriber profile information to host 104. Example subscriber profile information can include name, age group, address, attributes of the article they want to use to display visual content on, such as make and model of a vehicle in which a display system 110, under subscriber control will be housed, estimated average amount of time per day that will be spent displaying visual content on the article, typical geographical locations of the article and/or media content preferences, for example, advertising and messages the subscriber is willing to display on their vehicle. However, it should be realized that media content preferences may not always be available as subscriber profile information. It should be noted that the term article relates to that to which a subscriber 108 is desirous of visual content being displayed or being supported by, whether or not the article is owned, borrowed, leased, etc. by the subscriber. For example, a motorized vehicle can be a mobile article located in places of public traffic, such as an automobile, train, bike, boat, backpack, articles of clothing and etc. However, an article can be a more non-mobile article located in places of public traffic, such as a message board, a store front or other. The subscriber profile information including username and password information are stored with host 104. Upon registration, each subscriber 108 has agreed to display visual content on articles of which the subscriber or delegate of the subscriber is in control of. For example, a subscriber 108 or a delegate of the subscriber can house a display system 110 in a vehicle, or can house a display system in other types of permanent or non-permanent articles.

Therefore, upon client 106 submitting visual content to host 104, the visual content can be sent to display systems 110 for display on articles under the control of a subscriber 108 or delegate of the subscriber. In return for displaying a client's visual content, the amount of time subscriber 108 displays visual content is tracked along with other qualifying details and is converted into a rewards points or other type of rewards system for redemption of goods or services. The redemption of goods or services for reward points earned by subscriber 108 is processed by redemption service 111. With the ever increasing cost of living expenses, such as gas, insurance, groceries, vehicle costs, etc, subscribers 108 to media system 100 can benefit from displaying visual content from host 104 via the rewards program. The subscriber 108 can then redeem rewards in the form of retail gift certificates for goods, such as groceries, fuel, automobile maintenance and other services, entertainment, restaurants, automobile purchases and etc. It should be realized that this is one example of a reward program and other types of reward programs can be implemented. For example, a benefit provider, such as corporation, can offer display systems to employees or branch owners for their use. In this type of situation, visual content transmitted to the display systems provided by the benefit providers will only relate to benefit provider approved content. In exchange for the display the visual content approved by their employer or corporate entity, the employee or branch owner can receive rewards from the benefit provider, such as mileage rewards (if the benefit provider is an airline), or other intermediary rewards from credit card companies, wireless service providers and etc.

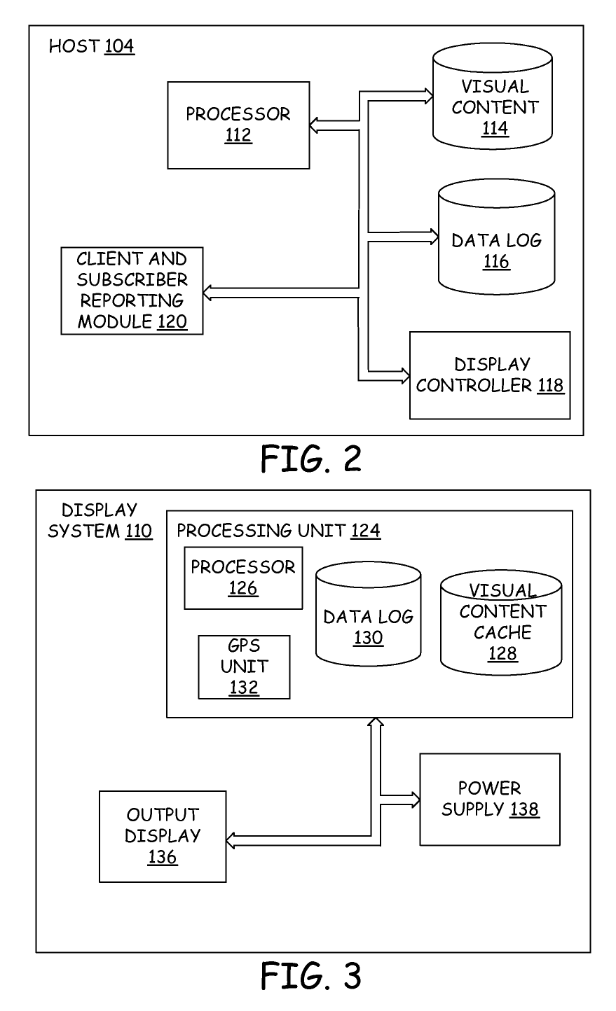

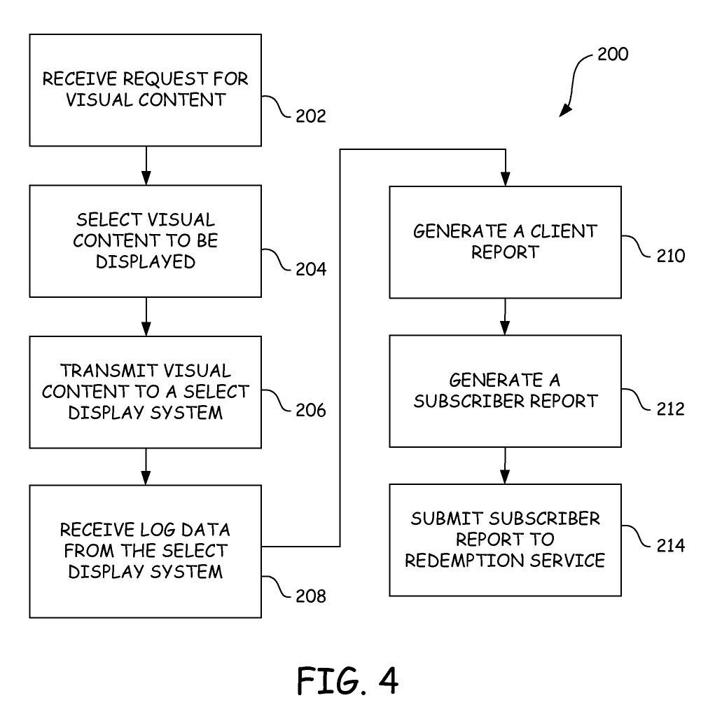

FIG. 2 illustrates a detailed schematic diagram of one embodiment of host 104. Host 104 includes a processor 112, a visual content storage device 114, a data log 116, a display controller 118 and a client and subscriber reporting module 120. FIG. 3 illustrates a detailed schematic diagram of an embodiment of one of the display systems 110 that is capable of being in communication with host 104 via network 102 (FIG. 1). Each display system 110 includes components capable of publicly displaying digital media. In one embodiment, display system 110 includes a processing unit 124 having a processor 126, a visual content cache 128, a data log 130 and a global positioning locator (GPS) unit 132. It should be realized that while it is illustrated that processor 126, visual content cache 128, data log 130 and global positioning locator (GPS) unit 132 are all located in processing unit 124, it should be realized that these components can be separate from processing unit 124. For example, GPS unit need only be co-located with the display or article of which the display is supported (i.e., mounted to the article, or mounted another mobile device traveling with the article). Display system 110 also includes an output display 136 and a power supply 138. In one embodiment, power supply 138 is configured to power processing unit 124 as well as output display 136. Each processing unit 124 of each display system 110 can be assigned a unique identifier which is used by host 104 to assign and download specific visual content. The unique identifier can be a static IP address assigned to a wireless modem in processing unit 124, a MAC address or any other type of assignment configuration. In addition, processing unit 124 can utilize an operating system. For example, processing unit 124 can be a handheld device that communicates with output display 136 wirelessly and instead of being powered by power supply 138, has its own power supply. Components illustrated in FIGS. 2 and 3 will be described in detail in combination with the method illustrated in FIG. 4.

FIG. 4 is a flowchart 200 illustrating a method of distributing visual content. At block 202, host 104 receives a request to distribute visual content to a select display system 110. In one embodiment, this request is received from the select display system 110 when it is powered up. In one embodiment, the request also includes a geographical location of the select display system 110 using the GPS unit 132. Since credits of a reward program are earned by the amount of time (or other quantifiable method) that visual content is displayed on a display system 110, subscribers 108 can choose to turn off their display system 110 at any time. In one embodiment, turning the display system 110 on, one can automatically request visual content from host 104. However, in another embodiment, host 104 can require that the display system 110 must be turned on and the article within which the display system is housed or displayed on is moving. In addition, the request to distribute visual content to a select display system can be initiated at pre-defined time intervals. For example, display system 110 can request updated data, such as new visual content from host 104 every 20 seconds (or other variable time) while display system is operating.

At block 204, host 104 selects visual content from visual content storage device 114 to be sent to select display system 110 for display. The selection of visual content may be based on the time of day, geographic location of the select display system 110 (which will receive the visual content), media content preferences stored in the subscriber profile of the subscriber 108 (who is in control of the display system 110) and vehicle attributes also stored in subscriber profile, such as make and model of vehicle, angle of rear window of the vehicle and etc. In addition, host 104 can remotely configure the display settings of the output display 136 in display system 110 using display controller 118 depending upon the visual content to be displayed, time of day of display, the make, model and angle of the rear window of the vehicle that houses the display system. For example, host 104 can configure the zoom, keystone correction brightness, contrast, screen size mode (full screen vs. normal), image orientation (standard vs. reverse) via network 102 by utilizing, for example, RS-232, RS-422, USB and etc. These example protocols are used for the case when output display 136 is a projector and allow for direct projector configuration by the processing unit 124. In the alternative, processing unit 124 can have an initialization script that configures these settings upon projector startup, or possibly the host may identify one or more projector settings that needs modifying and send this command via the network 102 to the processing unit 124, which in turn uses the RS-232 port to send the command to the projector.

At block 206, the selected visual content is transmitted to the select display system 110 for display. At block 208, host 104 receives log data from the select display system 110. Log data can include information regarding the time of day and length of time visual content was displayed, geographical location where visual content was displayed and etc. This information can be in any standard text or numeric digital format, such as ASCII or other.

At block 210, client and subscriber reporting module 120 generates client reports. Client reports include information pertaining to how long and where a select client's visual content was displayed and how much the client needs to pay for the display of their visual content. However, client reports can include other types of information. Client reports are accessible by clients 106 registered with host 104. For example, clients 106 can log in with their username and password to check the status of their account, upload visual content, pay bills, update profiles and perform other account-specific functions. In addition, clients 106 can find out where and when their visual content has been displayed in recent days, weeks and months by a targeted geographical area. This information can be accessed in a map-based graphical form and other formats. At block 212, client and subscriber reporting module 120 also generates subscriber reports. Subscriber reports include information pertaining to how long a select subscriber displayed visual content. Subscriber reports are accessible by subscribers 108 registered with host 104. For example, subscribers 108 can log in with their username and password to see how much time subscribers have displayed visual content on the article. At block 214, host 104 submits subscriber reports to redemption service 111. Redemption service 111 can use the generated reports to assign award points.

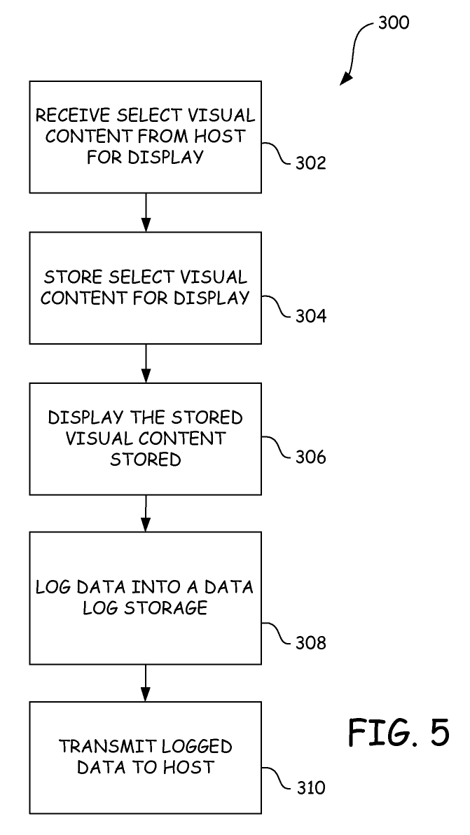

FIG. 5 is a flowchart 300 illustrating a method of displaying visual content. At block 302, a display system 110 receives select visual content from host 104 for display. As previously described, the selection of visual content by host 104 is based on the time of day, geographic location of the display system 110, media content preferences stored in the subscriber profile of the subscriber 108 (who is in control of the display system 110) and vehicle attributes also stored in subscriber profile, such as make and model of vehicle, year of the vehicle and etc. At block 304, display system 110 stores the received visual content in visual content cache 128. Visual content cache is a local memory in processing unit 124, such as Compact Flash or other onboard, built-in storage device.

At block 306, display system 110 displays the stored visual content from visual content cache 128. Processing unit 124 is configured to manipulate the stored visual content received from host 104 to transmit display content to output display 136 by, for example, standard wired VESA VGA protocol or any type of wireless transmission protocol. Processor 126 is configured to display each piece of visual content received from host 104 for a period of time on output display 136. For example, the visual content can be displayed for 4 to 10 seconds, with the average time being approximately 6 to 8 seconds. After elapse of the time period, the image can fade, dissolve or otherwise disappear and a transition, which lasts for at least a period of 1 second, occurs such that a new piece of visual content can be displayed for the allotted period of time. Such time periods follow regulations established for digital billboard image display criteria (i.e., 6 to 8 second image intervals with 1 to 2 second transition times between messages).

Output display 136 can be any type of display device that is able to display digital media. In one embodiment, output display 136 can be a projector that projects visual content onto an existing structure and/or a rear projection screen or film coupled to a structure. One such structure includes a window or door of a transportation vehicle or other type of window, acrylic, safety glass or glass such that people who are in visual contact with the window can view visual content. One way to project visual content, especially on transparent or at least partially transparent surfaces, such as windows or glass, is to project visual content onto the transparent or at least partially transparent surface that is coated or covered with a screen or film of polymer. Example polymers include optical films, optical foils and holographic or non-holographic flexible screens or films. The polymer can be a coating having translucent properties, a coating having opaque properties or can be a polyvinyl chloride that incorporates glass beads. In the alternative, the polymer or display capability can be built into the window, glass, acrylic or other transparent or semi-transparent surface. In this embodiment, the screen or film is coupled to a structure to enhance the brightness or contrast of the projected image to viewers. Such a screen or film can be fixed to or embedded in the transparent or semi-transparent surface using an adhesive or other attachment or embedded mechanism. In one embodiment, the film or screen can be attached to a retractable shade apparatus. The film or screen can be pulled and unrolled and then attached to a mechanism mounted to the window for use and then detached from the mechanism to retract into a rolled shape when not in use.

When projecting visual content onto these types of polymers coupled to glass or acrylic, the image is visible from both sides. However, especially with visual content that are textual, the image needs to be projected as a reverse image. While the image will show as inverted on the side that receives the image from a projector, the opposite side of the polymer will show the image as a non-inverted image to outside viewers. Therefore, when projecting a reverse image onto a polymer coupled to a window of a transportation vehicle, such as a rear window of a vehicle, the image will appear from inside of the vehicle as being in reverse and appear from outside of the vehicle as being not in reverse. If one were to look in the rear view mirror of the vehicle, however, the image would actually appear as a non-reverse image.

In one embodiment, the projector can be a non-coherent (non-laser), light-based projector. For example, the projector can include LCD, DLP or other technology. In another embodiment, the projector can be a laser-based projector. One or more lasers can serve as a light source for the projector. Mirrors, reflectors and other types of optics can be used to direct the laser light onto the structure in a pre-determined manner so as to control the laser light in such a way to create desirable black and white or colored images. In still another embodiment, the projector can be a LED-based projector. One or more LEDs can serve as the light source for the projector. Mirrors, reflectors and other types of optics can be used to direct the LED light onto the structure in a pre-determined manner so as to control the LED light in such a way to create an image.

In another output display embodiment, output display 136 can be a display screen using conventional display technologies, such as, but not limited to, a liquid crystal display (LCD), light emitting diode (LED), organic light emitting diode (OLED), plasma, and cathode ray tube (CRT). For example, the display screen can be mounted to an exterior of a structure or an interior of a substantially transparent structure such that the flat panel display is visible to people in visual contact with the exterior of the structure.

In another output display embodiment, output display 136 can be electronic paper or e-paper. E-paper is a display technology that reflects light, like ordinary paper, to mimic the appearance of ordinary ink on paper instead of using backlight to illuminate its pixels like conventional display technologies. E-paper forms digital text and images to be displayed by rearranging charged pigment particles using an applied electric field. E-paper can hold the arrangement of particles without drawing power and still later allowing the image to be changed.

In still another output display embodiment, output display 136 can be embedded into a transparent or substantially transparent structure (i.e., a window), for example, using filaments, fiber optics, etc., to allow an image to be presented on the structure by using static, chargeable or other type of display technology.

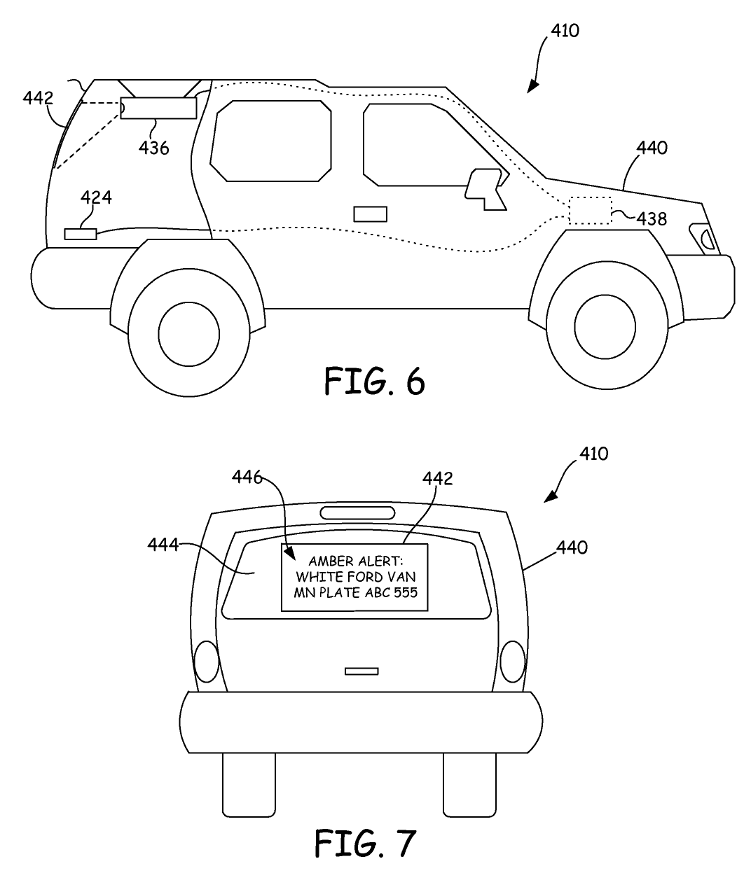

FIGS. 6 and 7 illustrate an example display system 410 housed in a vehicle that utilizes the above-described projection technology to project visual content onto a window of a vehicle 440. FIG. 6 illustrates a cut-away side view of vehicle 440 and FIG. 7 illustrates a rear view of vehicle 440. In FIGS. 6 and 7, vehicle 440 is an automobile. Display system 410 includes a processing unit 424, a projector 436 mounted internally within the vehicle 440, power supply 438 and optical film 442. Power supply 438 that provides power to processing unit 424 and projector 436 may also be the automobile battery for operating the vehicle. Optical film 442 is coupled to a rear window 444 of vehicle 440. However, it should be realized that optical film 442 can be attached to other windows of vehicle 440.

In accordance with the method illustrated in FIG. 5, processing unit 424 receives visual content from a host 104 (FIG. 1) via a network 102 (FIG. 1). Processing unit 424 instructs projector 436 to render the visual content or image 446 by projecting the visual content 446 onto film 442. Film 442 is such that although the image 446 is projected onto the side of the film facing the interior of the vehicle 440, the image 446 is also visible from the side of the film facing rear window 444. As illustrated in FIG. 7, image 446 is an AMBER alert announcement. It should be realized that image 446 can be any type of visual content including commercial and non-commercial advertisements, personal messages and other public announcements, etc.

With reference back to FIG. 5, at block 308, data is tracked or logged into data log 130. Logged data includes information specific to the visual content displayed on output display 136, 436. For example, how long output display 136, 436 displayed visual content, what visual content was displayed and geographical locations of where visual content was displayed. At block 310, logged data stored in log data storage 130 is transmitted to host 104 for use in generating client reports and subscriber reports previously discussed. Log data can be transmitted to host 104 at predefined time intervals. For example, every 20 seconds when the display system 110 is turned on.

With reference back to FIGS. 1-3 and in accordance with another embodiment, subscribers 108 can use the display systems 110 that are housed in their vehicle or otherwise under their control to display their own personal visual content. A subscriber 108 can log in to their account with host 104 and upload visual content for display. As previously described host 104 will screen the visual content for inappropriate content, vulgarity, obscenity and etc. Upon approval of the personal visual content uploaded by the subscriber 108, visual content will be sent to the specific display system 110 under control of the subscriber or subscriber delegate 108 for display as described in FIG. 4. In addition, subscriber 108 can access visual content storage device 114 for personal messages and images that have already been approved for display. The subscriber 108 can select one of these messages for transmission to their display system 110. For example, a personal piece of visual content can include a message reciting “God Bless the USA” and show an image of an American Flag or the image could be placeholder content when the subscriber has reached his or her monthly compensation limit.

In other embodiments, display system 110 can include a temperature sensor, in which its temperature data is logged into log data storage 130. If the external or internal temperature of the vehicle which houses the display system 110 is outside an approved operating temperature range, then no visual content is displayed by the display system 110. Display system 110 can include a light sensor in which upon output display initialization performs an on/off detection test verifying that the output display is working. The light sensor can also automatically adjust the brightness of the output display. Of course, brightness of the display can also be manually operated in the first product line via a push button or other control mechanism. A camera can also be co-located with display system 110 or within or on the article supporting the display. In one embodiment, the camera can capture the display of visual content such that proof can be sent to the client showing the visual content was displayed. This captured media data can be uploaded to host 104 along with the logged data. In another embodiment, a camera can be located at the back of the vehicle as a safety precaution. For example, if a driver is unable to see out the window with which a display is supported by, the driver can utilize a camera attached to the rear of the vehicle to see what is behind them.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A media system for displaying visual content comprising:
a display supported by an article;
a host remotely located from the display and coupled to the display over a communication network, the host comprising:
a computer storage medium including visual content, wherein at least a portion of the visual content is submitted to the host by a client;
a processor configured to selectively transmit visual content to the display and configured to receive data corresponding to display activity of the selected visual content on the display; and
a reporting module configured to report the data corresponding to the display activity to the client and a subscriber.

2. The media system of claim 1, wherein the data corresponding to display activity includes data representative of at least a value of time the selectively transmitted visual content was displayed.

3. The media system of claim 2, wherein the data received from the display further comprises geographical location data from a geographical locater co-located with the display.

4. The media system of claim 1, wherein the article comprises a motorized vehicle, wherein the display is arranged for viewing from a window of the motorized vehicle.

5. The media system of claim 1, wherein the host is configured to screen visual content before it is stored in the computer storage medium.

6. The media system of claim 1, wherein the host comprises a display controller configured to remotely control display settings of the display.

7. The media system of claim 1, wherein the host is responsive to profile information provided by the subscriber when selectively transmitting visual content to the display.

8. The media system of claim 1, further comprising a redemption service module coupled to the host by the communication network, the redemption service module configured to receive the report data from the reporting module to assign subscriber rewards points based on the data received from the display.

9. The media system of claim 1, wherein the visual content stored in the visual content storage further comprises visual content submitted by the subscriber for display on the display.

10. A method of distributing visual content comprising:
selecting visual content to be displayed on a remotely located display based on information provided by a subscriber, the display supported by an article;
transmitting the selected visual content to the display;
receiving data corresponding to display activity of the visual content on the display; and
reporting the data for access by the subscriber.

11. The method of claim 10, wherein the data corresponding to display activity of the visual content on the display comprises at least a value of time the selected visual content was displayed on the display.

12. The method of claim 11, wherein the data corresponding to display activity on the display received comprises geographical location data from a geographical locater co-located with the display.

13. The method of claim 10, further comprising screening the select visual content for unacceptable content before it is transmitted to the display.

14. The method of claim 10, further comprising remotely controlling display settings of the display.

15. The method of claim 10, further comprising transmitting the reported data to a redemption service, the redemption service configured to assign subscriber rewards points based on the data corresponding to the display activity on the display.

16. The method of claim 10, wherein selecting visual content comprises selecting visual content from visual content stored in a computer storage medium of which a portion of the visual content is submitted by a client desirous of displaying visual content on the display.

17. A display system comprising:
a display housed in a transportation vehicle and configured to render an image supported by a window of the transportation vehicle, the window including an exterior facing side which at least renders the image for viewing by a person exterior to the transportation vehicle; and
a processing unit including a storage device containing visual content received from a host remotely located from the display system and coupled to the processing unit through a communication network, the processing unit configured to transmit visual content to the display and transmit data to the host.

18. The display system of claim 17, wherein the data transmitted to the host comprises at least a value of time the visual content is displayed on the display.

19. The display system of claim 18, wherein the data transmitted to the host comprises geographical location data of the display.

20. The display system of claim 17, wherein the display comprises a projector mounted to an interior of the transportation vehicle and configured to project the image on an optical film coupled to the window of the transportation vehicle.
